(19) United States
(12) Patent Application Publication
(10) Pub. No.: US 2026/0054203 A1
(43) Pub. Date: Feb. 26, 2026

(54) FILTER COMPONENT

(71) Applicant: Grace Precision Products, LLC, Webb City, MO (US)

(72) Inventors: Michael Mann, Joplin, MO (US); David Wands, Columbus, KS (US)

(73) Assignee: Grace Precision Products, LLC, Webb City, MO (US)

(21) Appl. No.: 18/815,420

(22) Filed: Aug. 26, 2024

(51) Int. Cl. B01D 35/04; F16K 51/00

(52) U.S. Cl. CPC B01D 35/04; F16K 51/00; B01D 2201/34

(57) ABSTRACT

A filter component includes a sealing surface configured to sealingly engage a valve stem and a filter coupled to a valve seat. The filter is configured to remove contaminants from a stream of fluid flowing therethrough to protect the sealing surface and the valve stem from damage and to prevent blockage and/or damage to downstream components. A conduit seat is configured to secure a fluid conduit in alignment with an opening in the valve seat. The fluid conduit is configured to be coupled to a downstream component.

### FIELD OF THE INVENTION

The present invention relates generally to a valve assembly. More specifically, the invention relates to a valve assembly that employs a valve stem that provides an on-off function of the valve assembly.

### BACKGROUND

Stem and seat type liquid service valve assemblies are used to control a flow of liquid to specific regions of a liquid service system. Degradation of a valve stem, a valve seat and/or other downstream components of the system due to contaminants therein decreases the effectiveness and efficiency of the system. Downstream components can include a small diameter orifice, which can become clogged or abraded by such contaminates. In the prior art, the liquid service valve assembly includes the valve stem that is controlled by a manual or automated actuator and that engages a sealing surface of the valve stem with a sealing surface of the valve seat to control the flow of the liquid therethrough. Contaminants and/or other artifacts in the liquid may damage the valve stem and/or the valve seat of the system and prevent the valve assembly from effectively controlling the liquid. Further, contaminants and/or other artifacts in the liquid may damage downstream components, such as the small diameter orifice. Such damage prevents the valve assembly from being effective and may cause further damage to the system.

Prior art systems may employ a filter positioned upstream of the valve assembly to remove contaminants and/or artifacts in the flow of liquid therethrough. This upstream filter is not a part of the valve assembly that is normally maintained, and therefore not normally cleaned or replaced. Failure of the upstream filter may result in implosion thereof, which could block the flow of liquid to the valve assembly and to the downstream components. Alternatively, or in addition to, prior art systems may employ a filter that is positioned downstream of the valve stem and the valve seat to remove contaminants and/or artifacts in the liquid flowing therethrough. While the downstream filter does protect downstream components, it does not provide any protection for the valve stem and the valve seat. Furthermore, the downstream filter is not a part that is normally replaced during a valve assembly rebuild. Failure of the downstream filter may result in implosion thereof, which could block the flow of liquid to the downstream components.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The embodiments described herein relate to a filter component including: a sealing surface configured to sealingly engage a valve stem; an opening that extends through the sealing surface; a filter configured to remove contaminants from a stream of fluid; and a conduit seat configured to secure a fluid conduit in alignment with the opening, wherein the fluid conduit is configured to be coupled to a downstream component.

The embodiments described herein relate to a filter component including: a filter configured to be positioned between a sealing surface of a valve seat and a sealing assembly, wherein the filter is configured to remove contaminants from a stream of fluid.

The embodiments described herein relate to a filter component including: a sealing surface configured to sealingly engage a valve stem; an entry formed in the sealing surface that is in flow communication with an opening extending through the filter component; and a filter formed integrally and configured to remove contaminants from a stream of fluid; wherein the valve stem is movable through a cavity of the filter, the valve stem is configured to be engageable with the sealing surface to prevent the stream of fluid from flowing through the entry formed in the sealing surface, the valve stem is configured to be disengageable from the scaling surface to allow the stream of fluid to flow through the entry formed in the scaling surface, and the filter is configured to prevent contaminants in the stream of fluid from damaging the scaling surface and the valve stem.

### BRIEF DESCRIPTION OF THE DRAWING

Embodiments of the invention are described in detail below with reference to the attached drawing figures.

FIG. 1 is a front and side perspective view of an embodiment of a high pressure water application system that includes a valve assembly coupled to a cutting head assembly, which includes a small diameter orifice.

FIG. 2 is a cross sectional view of the embodiment of the high pressure water application system presented in FIG. 1, showing a position of a filter component within the valve assembly, a valve stem coupled to an actuator, and a fluid line in flow communication with a downstream orifice of a downstream component.

FIG. 3 is a detail view of the filter component presented in FIG. 2, showing the filter component that includes a filter coupled to a valve seat and the valve stem in sealing engagement with a sealing surface of the filter component.

FIG. 4 is a detail view of the filter component presented in FIG. 2, showing the valve stem retracted from the sealing surface such that when a liquid is provided through a valve inlet, the liquid is able to advance through a channel of the filter, then through a plurality of perforations formed in the filter, and finally through an opening extending through the valve seat that is in flow communication with the downstream component.

FIG. 5 is a detail view of the filter component presented in FIG. 2.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

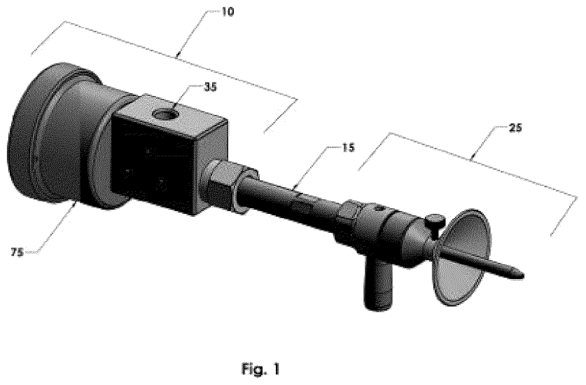

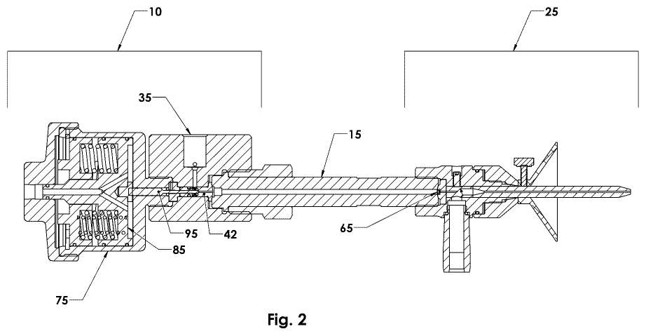

In an embodiment of a high pressure water application system shown in FIGS. 1 and 2, a valve assembly 10 includes a fluid conduit or nozzle tube 15 that extends therefrom and is configured to couple the valve assembly 10 to downstream components 25 that may include a small diameter orifice 65, such as, for example, the cutting head assembly described in U.S. patent application Ser. No. 18/645,175, entitled Cutting Head, which is incorporated herein by reference. In an embodiment, a pressure of the water or fluid in the high pressure system is between approximately 20,000 psi and approximately 100,000 psi. The valve assembly 10 is configured to be coupled to a pump (not shown) that provides a stream of fluid to a valve inlet 35 of the valve assembly 10. The valve assembly 10 includes a filter component 42 which integrates the valve seat 40 or the sealing surface 45 and a filter or screen 55. The filter or screen 55 is configured to remove contaminates, such as, for example, metal chips from cutting or threading operations, from the stream of fluid before the fluid flows through the fluid line 15 and into the downstream components 25, preventing damage to components of the valve assembly 10 including a valve stem 95 and the sealing surface 45, and preventing damage to the downstream component 25 including the small diameter orifice 65, thus preventing the deterioration of the quality of the stream of fluid therefrom.

A position of the filter 55 relative to the filter component 42 is significant because the filter component 42 is a consumable part of the valve assembly 10 that is replaced during regular maintenance of the valve assembly 10. Securement or integration of the filter 55 with the valve seat 40 to form the filter component 42 ensures that the filter 55 is replaced during the regular maintenance of the valve assembly 10. In an embodiment, the filter 55 is securable to the valve seat 40 to form the filter component 42, but not integral therewith, such that a user is able to consume existing valve seats 40 that do not include a filter coupled thereto.

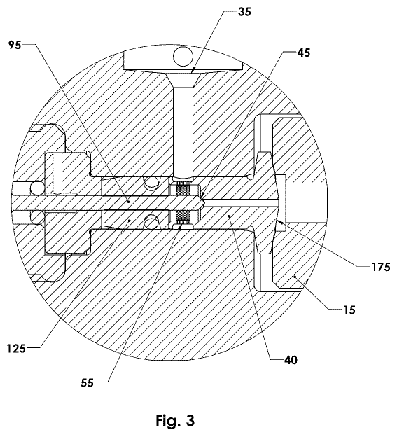

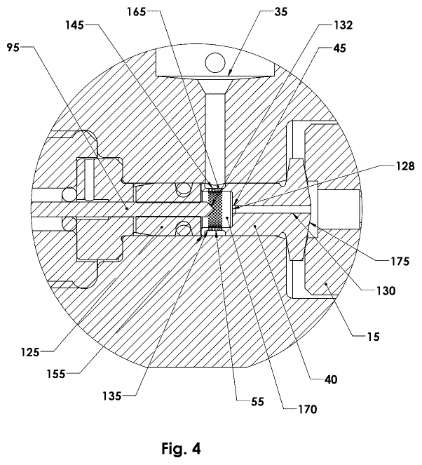

An embodiment of the valve assembly 10 is described herein. Although the valve assembly 10 is described relative to use with a high pressure water cutting head assembly 25, it is foreseeable that a valve assembly similar to the valve assembly 10 may be used in other liquid service applications. The valve assembly 10 may comprise an actuator 75 that is known in the art and that includes a piston 85 and the valve stem 95 movable by the piston 85 between a closed position that prevents the stream of fluid from flowing through at least the filter component 42, as shown in FIG. 3, and an open position that allows the stream of fluid to flow through the filter 55 and the filter component 42, as shown in FIG. 4, thereby filtering contaminants from the stream of fluid, protecting the stem 95 and sealing surface 45 from damage and preventing damage of downstream components 25.

A sealing assembly 125 is positioned adjacent to the filter component 42 and prevents fluid from flowing upstream or toward the actuator 75 and ensures all entering fluid is forced through the filter 55 coupled to the filter component 42.

As shown in FIG. 4, when the valve stem 95 is in the open or disengaged position the valve stem 95 is drawn away from the sealing surface 45, allowing the stream of fluid to flow through a plurality of perforations 145 of the filter 55 and then through a fluid entry or opening 128 formed through the sealing surface 45 that is in flow communication with an opening 130 in the filter component 42. The sealing assembly 125 ensures that all entering fluid flows through the plurality of perforations 145 of filter 55, and the filter 55 protects the stem 95 and sealing surface 45 from damage that may be caused by contaminants in the fluid and prevents damage of any downstream components 25 by such contaminants.

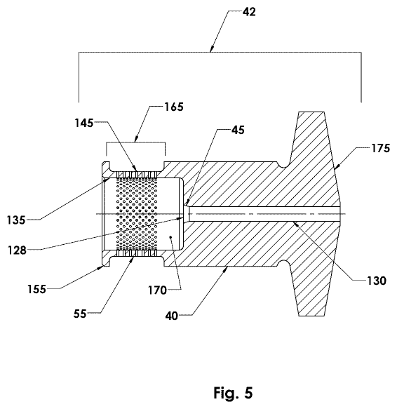

As shown in FIG. 5, the filter component is formed with the filter 55 on an end thereof. The filter 55 is positioned adjacent to the valve inlet 35 and between the sealing surface 45 and the sealing assembly 125 through which the valve stem 95 extends. The valve stem 95 is positioned to extend through a middle of the filter 55 to engage the sealing surface 45. The filter 55 comprises an annular wall 135 through which a plurality of perforations 145 extend and that connects the sealing surface 45 to a flange 155 that extends adjacent to the sealing assembly 125. Between the sealing surface 45 and flange 155, a channel 165 extends around the filter 55 through which the stream of fluid is able to flow through the perforations 145. The valve inlet 35 is configured to direct or provide the stream of fluid into the channel 165, which then flows through the perforations 145 of filter 55 and then into an interior cavity 170 within filter 55. As described herein, when the valve stem 95 is in the open position, the stream of fluid then flows through the entry 128 formed in the sealing surface 45 and into the opening 130 extending through the filter component. Contaminants in the stream of liquid are removed by the filter 55 prior to the fluid entering the cavity 170 of the filter 55, providing protection to a valve stem sealing surface 132 of the valve stem 95 that engages the sealing surface 45 such that a sealing relationship between the valve stem 95 and the sealing surface 45 is not compromised by the contaminants, and providing protection to downstream components 25 such as the orifice 65.

In an embodiment, the filter 55 may be integrally formed with the filter component 42. It is foreseeable that the filter 55 may be a separate and distinct part that is securable to and removable from, or removably coupled to, the filter component 42. The removable filter 55 may be locationally secured by its restricted position between the sealing surface 45 and the sealing assembly 125. Alternatively, it is foreseeable that the filter 55 may be secured to the filter component 42 by mechanical means.

The filter 55 includes the plurality of perforations 145 to remove contaminants from the stream of fluid. In an embodiment, the perforations 145 have a diameter of between approximately 0.001 inches and approximately 0.010 inches, and preferably between approximately 0.003 and approximately 0.008 inches.

In an embodiment, the filter 55 has between approximately 250 and approximately 600 perforations 145 formed therein, and preferably between approximately 300 perforations and approximately 500 perforations formed therein.

The filter component 42 also incorporates or is coupled to a fluid line seat or conduit seat 175 that secures and seals the fluid line 15 in alignment with the opening 130 in the filter component 42 and the downstream components 25 such as orifice 65 of the cutting head assembly 25, such that the opening 130 is in flow communication with the orifice 65 of the cutting head assembly 25.

The filter 55 prevents contaminants from flowing with the stream of fluid and through the fluid line 15 to the downstream components 25 such as the cutting head assembly 25 and blocking or damaging the orifice 65. In an embodiment, the orifice 65 has a diameter greater than or equal to a diameter of the perforations 145 formed in filter 55 such that a diameter of the contaminant that is able to pass through the perforations 145 is smaller than the orifice 65 and able to pass through the orifice 65 without causing damage thereto. Protection of the cutting head assembly 25, and specifically of the orifice 65, from contaminants in the stream of fluid reduces costs associated with replacement of parts and downtime for repair.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

Having thus described the invention, what is claimed as new and desired to be secured by Letters Patent is:

1. A filter component comprising:
a sealing surface configured to sealingly engage a valve stem;
an opening that extends through the sealing surface;
a filter configured to remove contaminants from a stream of fluid; and
a conduit seat configured to secure a fluid conduit in alignment with the opening, wherein the fluid conduit is configured to be coupled to a downstream component.

2. The filter component of claim 1, wherein the filter is configured to prevent contaminants from engaging the sealing surface.

3. The filter component of claim 1, wherein the filter is positioned between the sealing surface and a sealing assembly configured to direct the stream of fluid through the filter.

4. The filter component of claim 1, wherein the filter is formed integrally with the filter component.

5. The filter component of claim 1, wherein the filter is removably coupled to the filter component.

6. The filter component of claim 1, wherein the filter includes a plurality of perforations extending therethrough, and each of the plurality of perforations has a diameter of between approximately 0.001 inches and approximately 0.010 inches.

7. The filter component of claim 1, wherein the filter includes a plurality of perforations extending therethrough, and the plurality of perforations comprises between approximately 250 and approximately 600 perforations.

8. The filter component of claim 1, wherein the filter is configured to prevent contaminants from blocking or damaging the downstream component.

9. The filter component of claim 8, wherein the filter is configured to prevent contaminants from blocking or damaging an orifice of the downstream component.

10. The filter component of claim 1, wherein the filter component is a consumable part that is replaceable.

11. A filter component comprising:
a filter configured to be positioned between a sealing surface of a valve seat and a sealing assembly, wherein the filter is configured to remove contaminants from a stream of fluid.

12. The filter component of claim 11, wherein the filter is configured to prevent contaminants from engaging the sealing surface of the valve seat.

13. The filter component of claim 11, wherein the filter is configured to prevent contaminants from blocking or damaging an orifice of a downstream component.

14. The filter component of claim 13, wherein the filter includes a plurality of perforations, and the orifice of the downstream component has a diameter that is equal to or greater than a diameter of each of the plurality of perforations.

15. A filter component comprising:
a sealing surface configured to sealingly engage a valve stem;
an entry formed in the sealing surface that is in flow communication with an opening extending through the filter component; and
a filter configured to remove contaminants from a stream of fluid; wherein the valve stem is movable through a cavity of the filter,
the valve stem is configured to be engageable with the sealing surface to prevent the stream of fluid from flowing through the entry formed in the sealing surface,
the valve stem is configured to be disengageable from the sealing surface to allow the stream of fluid to flow through the entry formed in the sealing surface, and
the filter is configured to prevent contaminants in the stream of fluid from damaging the sealing surface and the valve stem.

16. The filter component of claim 15, further comprising a conduit seat configured to secure a fluid conduit in alignment with the opening, wherein the fluid conduit is configured to be coupled to a downstream component.

17. The filter component of claim 15, wherein the filter is configured to prevent contaminants from blocking or damaging a downstream component.

18. The filter component of claim 17, wherein the filter is configured to prevent contaminants from blocking or damaging an orifice that is a part of the downstream component.

19. The filter component of claim 18, wherein the filter includes a plurality of perforations, and the orifice of the downstream component has a diameter that is equal to or greater than a diameter of each of the plurality of perforations.

20. The filter component of claim 15, wherein the filter comprises an annular wall through which a plurality of perforations extend.
